(19) United States
(12) Patent Application Publication
(10) Pub. No.: US 2020/0326275 A1
(43) Pub. Date: Oct. 15, 2020

(54) NON-DESTRUCTIVE TESTING (NDT) BASED SETUPS WITH INTEGRATED LIGHT SENSORS

(71) Applicant: Illinois Tools Works Inc., Glenview, IL (US)

(72) Inventors: Sakif Bin Ferdous, Skokie, IL (US); David John Fry, Evanston, IL (US); Cheri Stockhausen, Gurnee, IL (US); Raymond D. Berry, III, Hoffman Estates, IL (US); David M. Geis, Chicago, IL (US)

(21) Appl. No.: 16/379,449

(22) Filed: Apr. 9, 2019

(51) Int. Cl. G01N 21/33; G01N 21/88; G01N 21/25

(52) U.S. Cl. CPC G01N 21/33; G01N 21/255; G01N 21/8803

(57) ABSTRACT

Systems and methods are provided for implementing and utilizing non-destructive testing (NDT) based setups with integrated light sensors. The light sensors may be configured for generating lighting-related sensory data (e.g., relating to ultraviolet (UV) light and/or white light) during lighting-based non-destructive testing (NDT) inspection, and the inspection may be managed or controlled based on the lighting-related sensory data.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

In some instances, dedicated material and/or products may be used in non-destructive testing. For example, non-destructive testing of particular type of articles may entail applying (e.g., by spraying on, pouring into, passing through, etc.), to the would-be tested article or part, a material that is configured for performing the non-destructive testing. In this regard, such material (referred to hereinafter as “NDT material” or “NDT product”) may be selected and/or made based on having particular magnetic, visual, etc. characteristics suitable for the non-destructive testing—e.g., allowing detecting defects, irregularities, and/or imperfections (referred to collectively hereinafter as “defects”) in the would-be tested article.

One form or type of NDT based inspections is lighting-based NDT inspections. In lighting-based NDT inspections, the inspection may be conducted visually with a light being used (e.g., in combination with NDT material applied to the to-be-inspected articles) to inspect for defects. In this regard, the defects may be visually identified based on, e.g., color contrast or some light-related behavior. The light used in such lighting-based NDT inspections may be available ambient light. Alternatively or additionally, a light source (e.g., special lamp) may be used to provide light meeting particular criteria for conducting the inspections. Lighting-based NDT inspections have their own unique set of challenges, however.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to product testing and inspection. More specifically, various implementations in accordance with the present disclosure are directed to methods and systems for implementing and operating non-destructive testing (NDT) based setups with integrated light sensors, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example lighting-based non-destructive testing (NDT) inspection setup, which may be configured for operation in accordance with the present disclosure.

FIG. 2 illustrates an example lighting-based non-destructive testing (NDT) inspection setup with integrated light sensors, in accordance with the present disclosure.

FIG. 3 illustrates an example controller for use in non-destructive testing (NDT) based setups incorporating use of inspection lamps with integrated light sensors, in accordance with aspects of the present disclosure.

FIG. 4 illustrates a flowchart of an example process for conducting lighting-based non-destructive testing (NDT) in an NDT inspection setup with integrated light sensors, in accordance with aspects of the present disclosure.

### DETAILED DESCRIPTION

Various implementations in accordance with the present disclosure are directed to providing enhanced and optimized lighting-based non-destructive testing (NDT) inspections, particularly by implementing and operating non-destructive testing (NDT) based setups with integrated light sensors. In this regard, as noted above, in lighting-based NDT inspections, the inspections may be conducted visually, typically with a light being used (e.g., in combination with NDT material applied to the to-be-inspected articles) to inspect for defects. For example, the defects may be visually identified based on exhibiting certain unique and identifiable characteristics, such as based on color contrast or some light-related behavior. Lighting-based NDT inspections have their own unique set of challenges, however. In this regard, existing solutions suffer from certain shortcomings that may hinder the effectiveness and/or cost of lighting-based NDT inspections. For example, existing solutions may not account for lighting conditions that may affect the inspections, particularly conditions that may exist (or become a factor) during the inspections—i.e., after the start of the inspection, at least without requiring stopping the inspections or otherwise alter the inspection environment. Therefore, NDT related machines or systems that overcome at least some of these shortcomings may be desirable.

Accordingly, implementations in accordance with the present disclosure address such issues and shortcomings, such as by providing lighting-based non-destructive testing (NDT) based setups that allow for monitoring and accounting for current lighting conditions.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein, an “inspection component” includes any component of a machine or an apparatus configured for performing or facilitating lighting-based non-destructive testing (NDT) inspection of articles. For example, an “inspection component” may include any one of: a structure or frame element of the machine or the apparatus as a whole and/or the setup where the inspection is performed, a holder component configured to hold the article being inspected (and to position it in a particular manner for conducting the inspection), a magnetization component configured for magnetizing the article being inspected (in magnetization based inspection), an application component configured for applying non-destructive testing (NDT) material to the article (e.g., in penetrant based inspection), a light source configured to emit light during the inspection, and the like.

An example non-destructive testing (NDT) apparatus in accordance with the present disclosure may include one or more inspection components configured for performing lighting-based non-destructive testing (NDT) inspection of an article; one or more light sensors configured for generating sensory data relating to ultraviolet (UV) light and/or white light; and one or more circuits configured to: process the sensory data; and generate based on the processing, lighting data relating to ultraviolet (UV) light and/or white light in and/or near an inspection area, where the article may be being inspected.

In an example implementation, the apparatus may comprise a feedback component configured to provide feedback to an operator of the system during the lighting-based non-destructive testing (NDT) inspection. The feedback component may comprise a visual output device.

In an example implementation, the feedback component may be configured to provide lighting-related feedback, based on the lighting data, relating to one or both of the ultraviolet (UV) light and/or the white light in and/or near an inspection area. The lighting-related feedback may comprise light intensity levels of one or both of ultraviolet (UV) light and/or white light in and/or near the inspection area.

In an example implementation, the one or more circuits may be configured to generate the lighting-related feedback based on the lighting data.

In an example implementation, at least one circuit of the one or more circuits may be incorporated into the feedback component.

In an example implementation, at least one light sensor of the one or more light sensors may be configured for communicating to at least one other component of the system the sensory data and/or data generated based on the sensory data. The at least one light sensor may be configured for communicating the sensory data and/or data generated based on the sensory data via a wired connection and/or a wireless connection.

In an example implementation, at least one circuit of the one or more circuits may be configured to communicate to at least one other component of the system the sensory data and/or data generated based on the sensory data.

In an example implementation, at least one circuit of the one or more circuits may be configured to communicate the sensory data and/or data generated based on the sensory data via a wired connection and/or a wireless connection.

In an example implementation, at least one circuit of the one or more circuits may be configured to control the lighting-based non-destructive testing (NDT) inspection; the controlling may comprise stopping the lighting-based non-destructive testing (NDT) inspection based on particular lighting-related criteria. The at least one circuit of the one or more circuits may be configured to assess the lighting-related criteria based on the sensory data and/or data generated based on the sensory data.

In an example implementation, at least one of the one or more light sensors may be fixed.

In an example implementation, at least one of the one or more light sensors may be movable, to enable an operator of the system to adaptively and/or selectively place the at least one of the one or more light sensors prior to start of the lighting-based non-destructive testing (NDT) inspection.

In an example implementation, at least one circuit of the one or more circuits may be incorporated into one of the one or more light sensors.

In an example implementation, at least one circuit of the one or more circuits may be incorporated into at least one of the one or more inspection components.

In an example implementation, the one or more inspection components may be configured for performing lighting-based magnetic particle inspection (MPI).

In an example implementation, the one or more inspection components may be configured for performing lighting-based liquid penetrant inspection (LPI).

An example method for lighting-based non-destructive testing (NDT) inspection, in accordance with the present disclosure, may include setting up an article for lighting-based non-destructive testing (NDT) inspection of the article, with the setting up comprising securing the article in a particular position, and applying to the article non-destructive testing (NDT) related material configured to exhibit one or more distinctive light related characteristics at areas in the article corresponding to defects; setting up one or more light sensors configure for generating sensory data relating to ultraviolet (UV) light and/or white light, with the setting comprising placing and/or adjusting positioning of at least one of the one or more light sensors; and conducting the lighting-based non-destructive testing (NDT) inspection of the article, based on lighting data relating to ultraviolet (UV) light and/or white light in and/or near an inspection area, the lighting data may be generated based on the sensory data generated by the one or more light sensors during the lighting-based non-destructive testing (NDT) inspection.

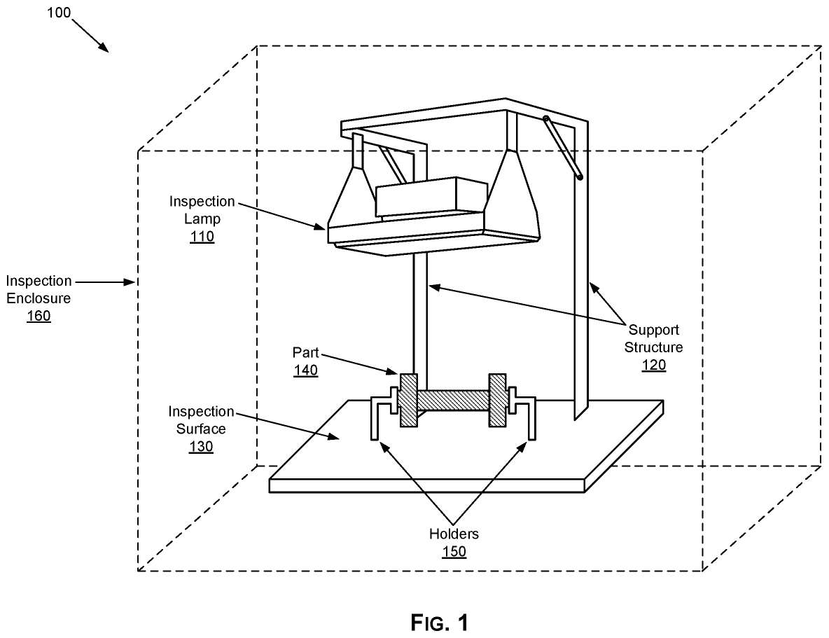

FIG. 1 illustrates an example lighting-based non-destructive testing (NDT) inspection setup, which may be configured for operation in accordance with the present disclosure. Shown in FIG. 1 is an NDT setup 100 which may be used in performing lighting-based NDT inspections.

The NDT setup 100 may comprise various components configured for non-destructive testing (NDT) inspection of articles (e.g., machine parts and the like), in accordance with particular NDT inspection methodology and/or techniques. Specifically, the NDT setup 100 may be configured for lighting-based NDT inspection. In this regard, in lighting-based NDT inspections, defects in inspected articles may be detected visually, particularly by use of light—e.g., ambient light or light projected on the inspected articles.

Thus, in some instances, lighting-based NDT inspections may entail use of a specially designed light source (e.g., a lamp), which may be configured to emit light in particular manner. In this regard, the emitted light may be white light, a light of other type (e.g., ultraviolet (UV) light), or any combination thereof. In some instances, lighting-based NDT inspections may entail use of NDT material, which is applied to the to-be-inspected articles. In this regard, defects may be visually identified based on, for example, color contrast or another light-related behavior, which may be caused or enhanced by the applied NDT material.

Various lighting-based NDT inspections techniques are used. The two main techniques are “magnetic particle inspection” (MPI) technique and the “liquid penetrant inspection” (LPI) technique, with the MPI technique typically being used with ferrous material, and the LPI technique typically being used with non-ferrous material (e.g., aluminum, brass, etc.). With either technique, the goal is to make defects visible when the article is visually examined (e.g., under the light source). Accordingly, in various implementations the NDT setup 100 may be configured for performing MPI based inspections and/or LPI based inspections.

As shown in FIG. 1, the NDT setup 100 comprises a light source (e.g., lamp) 110, which may be used in non-destructive testing (NDT) inspection of articles, using light emitted or projected by the lamp 110 on these articles. The lamp 110 may be attached to a support structure 120 such that it may project light downward onto an inspection surface 130, upon which an article (e.g., a machine part) 140 may be placed, being secured in particular position such as using holders 150, so that it may be inspected using the light projected by the lamp 110.

The NDT setup 100 may be configured for use ultraviolet (UV) in lighting-based NDT inspections, alone or in combination with white (or visible) light. Accordingly, the lamp 110 may be configured for generating and/or projecting ultraviolet (UV) light. In some instances, the lamp 110 may also emit white (or visible) light. Alternative, if needed, ambient white light is used. The lamp 110 may be any suitable light source. In some instance, the lamp 110 may be implemented in accordance with any of the implementation described in U.S. patent application Ser. No. 16/049,567, filed on Jul. 30, 2018, and entitled “Broad-Beam Ultraviolet (UV) Inspection Lamp For Use In Non-Destructive Testing (NDT).”

To enhance performance (e.g., improve ability to detect defects), an inspection enclosure 160 may be used. In this regard, the inspection enclosure 160 may be used to a suitable lighting environment for the inspection, such as by blocking or otherwise limit ambient light. This may be done to ensure that most of the light within the NDT setup 110 is that originating from the lamp 110, thus allowing controlled lighting environment for the inspections. The inspection enclosure 160 may be configured, for example, as a tent-like structure or any other structure that provide sufficient shading. Further, the inspection enclosure 160 may be adjustable—e.g., based on the user's preferences, surrounding space, etc.

In some instances, performance in lighting-based NDT inspection may be adversely affected by certain lighting related conditions and/or issues. For example, despite use of the inspection enclosure 160, there may be sufficient ambient light leaking into the inspection area (even though it may not be detected by the user), which may affect the accuracy or reliability of the lighting-based NDT inspections being performed therein. Also, in some instances, there may be issues or defects in the light source (e.g., the lamp 100) which may not be detected by the user, which may affect the accuracy or reliability of the lighting-based NDT inspections being performed therein. Thus, lighting-based NDT inspections may be enhanced by incorporating measures for handling such conditions.

Accordingly, in various implementations in accordance with the present disclosure, lighting-based NDT inspections may be enhanced by incorporating measures for monitoring lighting conditions, and for providing suitable actions related thereto, such as to notify the user, to take corrective measures, etc.

In some example implementations, this may be achieved by incorporating light sensors within into the NDT setup. Such light sensors may be fixed (e.g., built-in to some of the existing components in the NDT setup) and/or moveable, to allow the user some flexibility in determining where to place them within the NDT setup, such as based on the user preferences, unique characteristics associated with the inspections (e.g., the particular article being inspected), etc. The light sensors may be configured to generate sensory information based on detected lighting conditions. The sensory information then may be used to enhance lighting-based NDT inspection performed within the NDT setup.

For example, lighting related information (e.g., light intensity data) may be obtained based on the sensory information. The lighting related information may be used to enhance the lighting-based NDT inspection. For example, lighting related information may be provided (e.g., displayed) to the user, to allow the user to confirm the light conditions consistent with reliable inspection. The lighting related information may also be used as control data for controlling some of the other components in the NDT setup (e.g., the lamp).

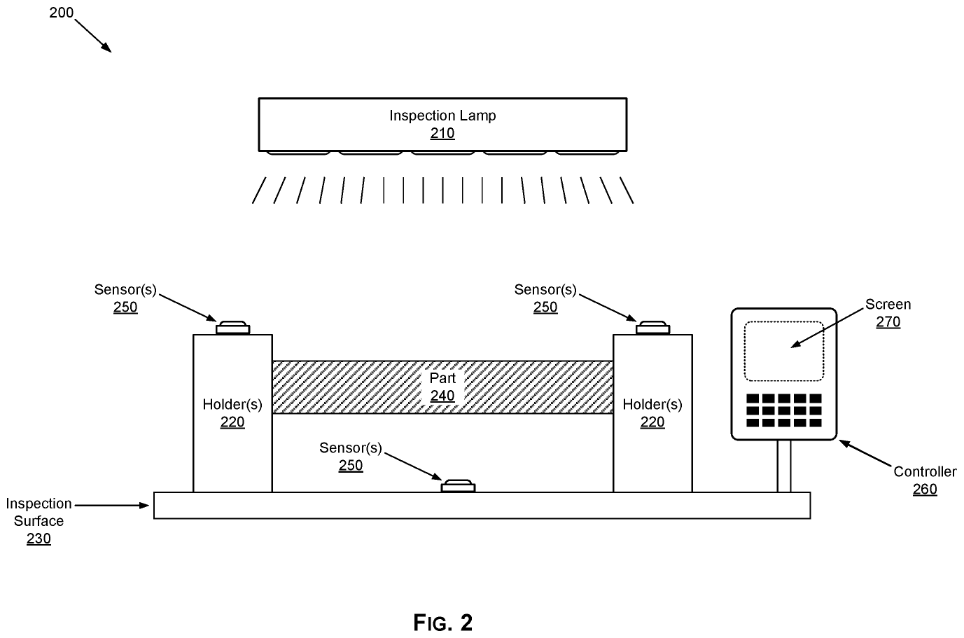

A particular example implementation is described with respect to FIG. 2.

FIG. 2 illustrates an example lighting-based non-destructive testing (NDT) inspection setup with integrated light sensors, in accordance with the present disclosure. Shown in FIG. 2 is an NDT setup 200 which may be used in performing lighting-based NDT inspections.

The NDT setup 200 may comprise various components configured for lighting-based non-destructive testing (NDT) inspections, as described with respect to FIG. 1. In this regard, the NDT setup 200 may be configured for performing MPI lighting-based inspections and/or LPI lighting-based inspections.

As shown in FIG. 2, the NDT setup 200 comprises a light source (e.g., lamp) 210, which may be configured for emitting and/or projecting light onto articles being inspected. The lamp 210 may be similar to the lamp 110 as described with respect to FIG. 1. Thus, the lamp 210 may be configured for generating and emitting ultraviolet (UV) light. The lamp 210 may be arranged within the NDT setup 200 to emit and/or project light onto an inspection surface 230, upon which an article (e.g., a machine part) 240 may be placed, being secured in a particular position such as using holders 220, so that it may be inspected using the light projected by the lamp 210.

The NDT setup 200 may configured for monitoring lighting conditions, and for providing suitable actions related thereto for enhancing and/or optimizing performance lighting-based NDT inspections performed therein, such as providing lighting related feedback to an operator utilizing the NDT setup 200, taking autonomous corrective measures, etc. In this regard, as explained with respect to FIG. 1, certain lighting related conditions and/or issues may affect lighting-based NDT inspections, particularly reliability and accuracy thereof. For example, ambient light may affect outcome of lighting-based NDT inspections (e.g., resulting in false pass or fail determinations). Similarly, undetected or noticed issues or defects in the light source (e.g., the lamp 200) may also affect outcome of lighting-based NDT inspections (e.g., similarly resulting in false pass or fail determinations).

For example, as shown in the example implementation illustrated in FIG. 2, the NDT setup 200 may incorporate one or more light sensors 250, which may be used within the NDT setup 200 to monitor lighting conditions, during lighting-based NDT inspections, with the NDT setup 200 being configured to use information obtained based on such monitoring during these lighting-based NDT inspections.

Each light sensor 250 may comprise suitable hardware (including circuitry) for detecting light and/or particular characteristics associated thereto, and for generating corresponding sensory information. For example, each light sensor 250 may comprise suitable hardware configured for reacting in particular manner (e.g., chemical change in a material, changes in electromagnetic characteristics, etc.) in response to particular light conditions (e.g., ambient light having intensity above a certain threshold). The “sensory information” generated by the light sensors 250 may comprise actual information—that is, data of some type. In this regard, the sensory information may be as basic as mere indication when a certain condition occurs; alternatively the sensory information may comprise more complex information—e.g., actual measurements corresponding to particular lighting conditions or characteristics, related data (e.g., temporal, spatial, etc.) associated with the conditions or measurement, and the like. Nonetheless, the disclosure is not so limited. Thus, in some implementations, the sensory information may merely be signals (e.g., electrical pulses), which may be triggered when certain detection conditions are met, and which (the signals) may be interpreted as “information” by a components receiving the signals—e.g., based on particular characteristics of the signals (e.g., amplitude).

In some instances, the light sensors 250 are fixed. In this regard, the light sensors 250 may be embedded, built-in, or otherwise permanently attached to one of the other components in the NDT setup 200, such as into the holders 220, the inspection surface 230, etc.

In some implementations, however, at least one of the light sensors 250 may be moveable and/or adjustable. Such moveable and/or adjustable sensor may be configured to enable temporary placement and/or adjustment of position thereof within the NDT setup. For example, the moveable and/or adjustable sensor may comprise an attachment element (e.g., clip-like component) to enable its attachment to certain points in the NDT setup 200. This may allow the user some flexibility in determining where and how to place the moveable and/or adjustable sensor within the NDT setup 200, such as based on the user preferences (e.g., to ensure that the sensor would not interfere with the inspection), to optimize inspection (e.g., based on the article being inspected, inspection parameters, etc.), and the like.

The light sensors 250 may be configured to communicate with at least one other component of the system. For example, the light sensors 250 may be configured for supported wired and/or wireless connections. Accordingly, each light sensor 250 may comprise suitable circuitry for facilitating such connections, and communications using these connections.

The light sensors 250 may be configured to use available connections (wired and/or wireless) to communicate the sensory data to at least one other component of the system, which may configured to use the sensory information to enhance the lighting-based NDT inspection. For example, the sensory information may be processed, such as generate or determine corresponding lighting related information (e.g., light intensity data, corresponding to white (visual) light and ultraviolet (UV) light) corresponding to the area where the inspection is being performed (e.g., where the light is projected) and/or near that inspection area.

The NDT setup 200 may be configured for performing particular actions taken based on the sensory information, and/or the processing thereof, with these actions being configured to enhance the lighting-based NDT inspection. For example, lighting related information (or data based thereon) may be provided to the user, which may allow the user to confirm that ambient light conditions are consistent with reliable inspection outcomes. The lighting related information may also be used as control data for controlling some of the other components in the NDT setup (e.g., the lamp 210).

The processing of the sensory information may be performed in components other than the light sensors 250. Such component may be configured to handle such processing. In this regard, the component may comprise suitable circuitry for performing the necessary processing. For example, as shown in FIG. 2, the NDT setup 200 may comprise a controller 260, which may comprise suitable circuitry for handling the processing of the sensory information, and/or for performing and/or controlling any actions taken based on the processing of the sensory information. The controller 260 may incorporate a screen or display 270, for example, which may be used to display light intensity levels calculated based on the sensory information obtained by the light sensors. The disclosure is not so limited, however, and as such other combination or variations may be supported. For example, the “controller” may comprise an already included controller circuitry (e.g., controller circuitry for the lamp 210), which may be configured to performed some the required processing functions. Further, in some instances, at least some of the processing may be performed within at least one of the lighting sensors 250. In such implementations, such lighting sensor may comprise suitable circuitry for handling the required processing.

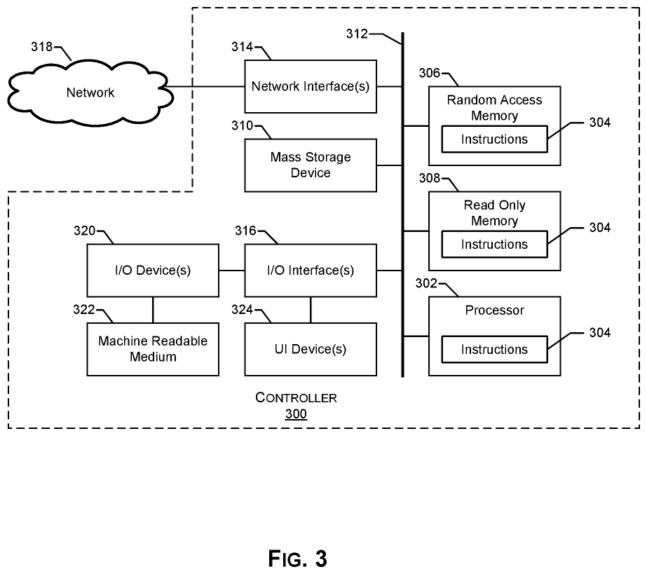

FIG. 3 illustrates an example controller for use in non-destructive testing (NDT) based setups incorporating use of inspection lamps with integrated light sensors, in accordance with aspects of the present disclosure. Shown in FIG. 3 is a controller system 300.

The controller system 300 may comprise suitable circuitry for implementing various aspects of the present disclosure, particularly for supporting automated sample collection in magnetic wet benches, as described with respect to FIG. 1. In this regard, the controller system 300 may represent an example implementation of the controller unit 260 of FIG. 2. Accordingly, the control system 300 may be configured for supporting lighting-based NDT inspections, particularly in setups incorporating integrated light sensors and use thereof. For example, the control system 300 may be configured for performing at least some of the processing of the sensory information generated by the light sensors, and for taking or supporting actions taken based on sensory information—e.g., including providing feedback to the user, such as via available output devices (e.g., display or screen).

As shown in FIG. 3, the controller system 300 may include a processor 302. In this regard, the example processor 302 may be any general purpose central processing unit (CPU) from any manufacturer. In some example implementations, however, the processor 302 may include one or more specialized processing units, such as RISC processors with an ARM core, graphic processing units, digital signal processors, and/or system-on-chips (SoC).

The processor 302 executes machine readable instructions 304 that may be stored locally at the processor (e.g., in an included cache or SoC), in a random access memory (RAM) 306 (or other volatile memory), in a read only memory (ROM) 308 (or other non-volatile memory such as FLASH memory), and/or in a mass storage device 310. The example mass storage device 310 may be a hard drive, a solid state storage drive, a hybrid drive, a RAID array, and/or any other mass data storage device.

A bus 312 enables communications between the processor 302, the RAM 306, the ROM 308, the mass storage device 310, a network interface 314, and/or an input/output (I/O) interface 316.

The example network interface 314 includes hardware, firmware, and/or software to connect the controller system 300 to a communications network 318 such as the Internet. For example, the network interface 314 may include IEEE 202.X-compliant wireless and/or wired communications hardware for transmitting and/or receiving communications.

The example I/O interface 316 of FIG. 3 includes hardware, firmware, and/or software to connect one or more user interface devices 320 to the processor 302 for providing input to the processor 302 and/or providing output from the processor 302. For example, the I/O interface 316 may include a graphics processing unit for interfacing with a display device, a universal serial bus port for interfacing with one or more USB-compliant devices, a FireWire, a field bus, and/or any other type of interface.

The example controller system 300 includes a user interface device 324 coupled to the I/O interface 316. The user interface device 324 may include one or more of a keyboard, a keypad, a physical button, a mouse, a trackball, a pointing device, a microphone, an audio speaker, an optical media drive, a multi-touch touch screen, a gesture recognition interface, and/or any other type or combination of types of input and/or output device(s). While the examples herein refer to a user interface device 324, these examples may include any number of input and/or output devices as a single user interface device 324. Other example I/O device(s) 320 an optical media drive, a magnetic media drive, peripheral devices (e.g., scanners, printers, etc.), and/or any other type of input and/or output device.

The example controller system 300 may access a non-transitory machine readable medium 322 via the I/O interface 316 and/or the I/O device(s) 320. Examples of the machine readable medium 322 of FIG. 3 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

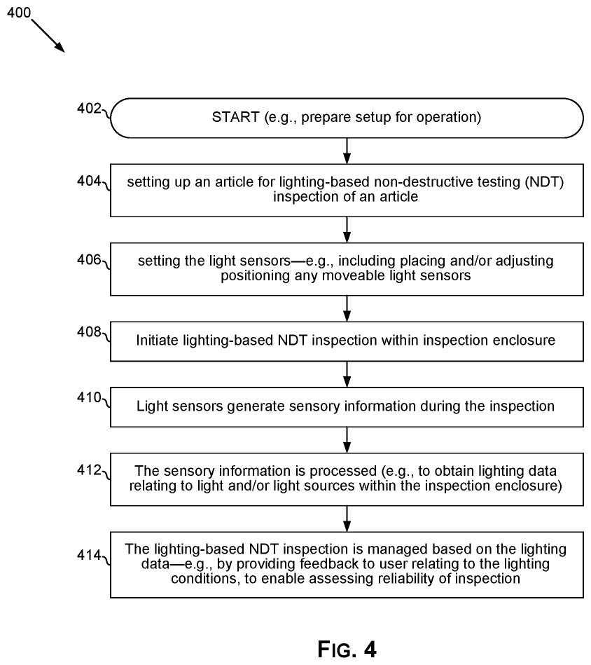

FIG. 4 illustrates a flowchart of an example process for conducting lighting-based non-destructive testing (NDT) in an NDT inspection setup with integrated light sensors, in accordance with aspects of the present disclosure. Shown in FIG. 4 is flow chart 400, comprising a plurality of example steps (represented as blocks 402-412), which may be performed in a suitable system (e.g., setup 200 of FIG. 2) to provide lighting-based non-destructive testing (NDT) inspection in accordance with the present disclosure.

In start step 402, the lighting-based NDT inspection setup is prepared for inspection (e.g., powering on components thereof, setting up the enclosure area, etc.).

In step 404, an article being inspected may be setup for lighting-based non-destructive testing (NDT) inspection of an article. Setting up the article may include, for example, securing the article in a particular position, applying to the article any necessary non-destructive testing (NDT) related material (e.g., for exhibiting particular lighting-related characteristics), etc.

In step 406, the integrated light sensors may be setup for the inspection. This may include placing and/or adjusting positioning any moveable light sensors. In this regard, the integrated light sensors are configured for providing lighting-related monitoring during the inspection, without requiring any change to the inspection environment (e.g., without requiring opening or otherwise changing the lighting conditions within the inspection enclosure).

In step 408, the lighting-based NDT inspection of the article within the inspection enclosure may be initiated.

In step 410, light sensors generate sensory information during the inspection. Where necessary, the sensory information or data obtained based thereon may be communicated form the light sensors to other inspection components in the setup.

In step 412, the sensory information is processed (e.g., within the light sensors, in other inspection components within the setup, or any combination thereof). The processing may allow obtaining useful lighting-related data—e.g., lighting data relating to light and/or light sources within the inspection enclosure)

In step 414, the lighting-based NDT inspection may be managed based on the lighting data—e.g., by providing feedback to user relating to the lighting conditions, to enable assessing reliability of inspection, etc.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

1. A system for use in non-destructive testing (NDT), the system comprising:
one or more inspection components configured for performing lighting-based non-destructive testing (NDT) inspection of an article;
a feedback component configured to provide feedback during the lighting-based non-destructive testing (NDT) inspection;
one or more light sensors configured for generating sensory data relating to at least ultraviolet (UV) light; and
one or more circuits configured to:
process the sensory data; and
generate based on the processing, lighting data relating to at least ultraviolet (UV) light in or near an inspection area, where the article is being inspected; and
wherein the feedback component is configured to provide lighting-related feedback, based on the lighting data, relating to one or both of the ultraviolet (UV) light and white light in or near an inspection area.

2. (canceled)

3. The system of claim 1, wherein the feedback component comprises a visual output device.

4. (canceled)

5. The system of claim 1, wherein the lighting-related feedback comprises light intensity levels of one or both of ultraviolet (UV) light and the white light in or near the inspection area.

6. The system of claim 1, wherein the one or more circuits are configured to generate the lighting-related feedback based on the lighting data.

7. The system of claim 1, wherein at least one circuit of the one or more circuits is incorporated into the feedback component.

8. The system of claim 1, wherein at least one light sensor of the one or more light sensors is configured for communicating to at least one other component of the system the sensory data and/or data generated based on the sensory data.

9. The system of claim 8, wherein the at least one light sensor of the one or more light sensors is configured for communicating at least one of the sensory data or data generated based on the sensory data via at least one of a wired connection or a wireless connection.

10. The system of claim 1, wherein at least one circuit of the one or more circuits is configured to communicate to at least one other component of the system at least one of the sensory data or data generated based on the sensory data.

11. The system of claim 10, wherein at least one circuit of the one or more circuits is configured to communicate at least one of the sensory data or data generated based on the sensory data via a wired connection and/or a wireless connection.

12. The system of claim 1, wherein at least one circuit of the one or more circuits is configured to generate, based on at least one of the sensory data or data generated based on the sensory data, control data configured for controlling one or both of the lighting-based non-destructive testing (NDT) inspection and operations of at least one component of the system.

13. The system of claim 1, wherein the at least one circuit of the one or more circuits is configured to control based on at least one of the sensory data or data generated based on the sensory data, one or both of the lighting-based non-destructive testing (NDT) inspection and operations of at least one component of the system.

14. The system of claim 1, wherein at least one of the one or more light sensors is fixed.

15. The system of claim 1, wherein at least one of the one or more light sensors is movable, to enable an operator of the system to at least one of adaptively or selectively place the at least one of the one or more light sensors prior to start of the lighting-based non-destructive testing (NDT) inspection.

16. The system of claim 1, wherein at least one circuit of the one or more circuits is incorporated into one of the one or more light sensors.

17. The system of claim 1, wherein at least one circuit of the one or more circuits is incorporated into at least one of the one or more inspection components.

18. The system of claim 1, wherein the one or more inspection components are configured for performing one of: lighting-based magnetic particle inspection (MPI) and lighting-based liquid penetrant inspection (LPI).

19. (canceled)

20. A method for lighting-based non-destructive testing (NDT), the method comprising:
setting up an article for lighting-based non-destructive testing (NDT) inspection of an article; wherein the setting up comprises:
securing the article in a particular position;
applying to the article non-destructive testing (NDT) related material configured to exhibit one or more distinctive light related characteristics at areas in the article corresponding to defects;
setting up one or more light sensors configured for generating sensory data relating to at least ultraviolet (UV) light, wherein the setting up comprises placing and/or adjusting positioning of at least one of the one or more light sensors; and
conducting the lighting-based non-destructive testing (NDT) inspection of the article, based on lighting data relating to at least ultraviolet (UV) light in or near an inspection area, wherein:
the lighting data is generated based on the sensory data generated by the one or more light sensors during the lighting-based non-destructive testing (NDT) inspection; and
conducting the lighting-based non-destructive testing (NDT) inspection comprises verifying based on the lighting data that lighting conditions within an area around the article match predefined lighting criteria for the inspection.

21. The system of claim 1, wherein:
at least one sensor of the one or more light sensors is configured for generating sensory data relating to white light; and
the one or more circuits are configured to:
process the sensory data; and
generate based on the processing, lighting data relating to white light in or near the inspection area.
